(19) United States
(12) Patent Application Publication
(10) Pub. No.: US 2021/0334381 A1
(43) Pub. Date: Oct. 28, 2021

(54) METHOD AND ELECTRONIC DEVICE CAPABLE OF SECURELY STORING AND LOADING FIRMWARE

(71) Applicant: Realtek Semiconductor Corp., HsinChu (TW)

(72) Inventors: TIANYI ZHU, Suzhou City (CN); ZHAOMING LI, Suzhou City (CN); Zuohui Peng, Suzhou City (CN)

(21) Appl. No.: 17/123,143

(22) Filed: Dec. 16, 2020

(30) Foreign Application Priority Data
Apr. 28, 2020 (CN) 202010349422.5

(51) Int. Cl. G06F 21/57; G06F 21/60; G06F 21/79

(52) U.S. Cl. CPC G06F 21/572; G06F 21/575; G06F 2221/0751; G06F 21/79; G06F 21/602

(57) ABSTRACT

A method capable of securely storing and loading firmware includes: dividing operating system environment into a secure world and a non-secure world wherein the secure world includes read-only memory and one-time programmable circuit configured within electronic device while non-secure world includes flash memory externally coupled to electronic device; reset handler of read-only memory performs boot up when system is powered up and is used to load initialization program code; using specific initialization program code to initialize decryption engine; obtaining key from one-time programmable circuit and loading key to configure decryption engine; reading cipher text of firmware from flash memory; decrypting cipher text of firmware to generate plain text of firmware; and determining whether secure boot procedure successfully completes according to cipher text and plain text.

### BACKGROUND OF THE INVENTION

### 1. Field of the Invention

The invention relates to a mechanism for securely storing and loading firmware, and more particularly to a method and an electronic device capable of securely/safely storing and loading firmware.

### 2. Description of the Prior Art

At present, the applications of IoT (Internet of Things) devices are very popular. In order to solve the security problems comprising information leakage, illegal/invalid access or the attacks of malicious program for the IoT devices, a conventional method may divide resources of a system operating environment into a trusted zone and a normal/common zone. Since the trusted zone and the normal/common zone are two independent execution environments, the unauthorized programs of the normal/common zone cannot access the resources of the trusted zone, and thus this protects the data content of the trusted zone within a circuit chip from malicious software's attacks.

However, the firmware program of an IoT device is generally stored in a non-volatile memory classified into the normal zone, e.g. an externally connected flash memory. When the system of the IoT device is started, the firmware program will be copied from the externally connected flash memory and loaded into the random access memory within the IoT device. Since the externally connected flash memory easily suffers from the problems of information leakage, illegal access, or malicious program's attacks, the conventional solution method cannot ensure that the whole boot procedure comprising loading the firmware from the normal zone into the trusted zone is safe and secure.

### SUMMARY OF THE INVENTION

Therefore one of the objectives of the invention is to provide a method and mechanism for safely/securely copying and loading firmware, to securely loading and decrypting the firmware from an external memory into a secure storage region inside an electronic device, to thereby avoiding the tampered firmware running on the system of the electronic device.

According to embodiments of the invention, a method for securely storing and loading a firmware is disclosed. The method comprises: dividing an operating system environment of an electronic device into a secure world and a non-secure world wherein the secure world comprises a read-only memory and a one-time programmable circuit which are configured within the electronic device while the non-secure world comprises a flash memory externally coupled to the electronic device; starting and executing a reset handler of the read-only memory to load a specific initialization program code when a system of the electronic device is powered up; using the specific initialization program code to initialize a decryption engine; obtaining a key from the one-time programmable circuit and loading the key into the decryption engine; reading a cipher text of the firmware from the flash memory; decrypting the cipher text of the firmware to generate a plain text of the firmware by using the decryption engine and the key; and determining whether a secure boot procedure successfully completes according to the cipher text of the firmware and the plain text of the firmware.

According to the embodiments, an electronic device capable of securely storing and loading a firmware is disclosed. The electronic device is externally coupled to a flash memory which belongs to a non-secure world of an operating system environment of the electronic device, and the electronic device comprises a read-only memory, a one-time programmable circuit, a decryption engine circuit, and a processor. The read-only memory is used for storing a specific initialization program code, and the read-only memory belongs to a secure world of the operating system environment of the electronic device. The one-time programmable circuit is used for storing a key, and the one-time programmable circuit belongs to the secure world of the operating system environment of the electronic device. The decryption engine circuit is used for decrypting the firmware, and the decryption engine circuit belongs to the secure world of the operating system environment of the electronic device. The processor is coupled to the read-only memory, the one-time programmable circuit, and the decryption engine circuit. The processor based on a default/preset setting is arranged for starting and executing a reset handler of the read-only memory when a system of the electronic device is powered up, and is used for loading an initialization program code and using the initialization program code to initiate the decryption engine circuit. The decryption engine circuit after being initialized is arranged for obtaining the key from the one-time programmable circuit and loading and configuring the key into the initialized decryption engine circuit, reading a cipher text of the firmware from the flash memory, decrypting the cipher text of the firmware to generate a plain text of the firmware by using the key, and determining whether a secure boot procedure successfully completes according to the cipher text of the firmware and the plain text of the firmware.

According to the embodiments, an electronic device capable of securely storing and loading a firmware is disclosed. The electronic device is externally coupled to a flash memory which belongs to a non-secure world of an operating system environment of the electronic device, and the electronic device comprises a read-only memory, a one-time programmable circuit, and a processor. The read-only memory is used for storing a specific initialization program code, and the read-only memory belongs to a secure world of the operating system environment of the electronic device. The one-time programmable circuit is used for storing a key, and the one-time programmable circuit belongs to the secure world of the operating system environment of the electronic device. The processor based on a default/preset setting is coupled to the read-only memory and the one-time programmable circuit, and the processor is arranged for starting and executing a reset handler of the read-only memory and is used for loading an initialization program code and using the initialization program code to initiate the decryption engine circuit after a system of the electronic device is powered up. The processor is arranged for obtaining the key from the one-time programmable circuit, loading and configuring the key into a decryption engine software program, reading a cipher text of the firmware from the flash memory, using the key and the decryption engine software program to decrypt the cipher text of the firmware to generate a plain text of the firmware, and determining whether a secure boot procedure successfully completes according to the cipher text of the firmware and the plain text of the firmware.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic device capable of safely/securely storing and loading a firmware according to an embodiment of the invention.

FIG. 2 is a schematic diagram of an example flow of the startup program of the electronic device shown in FIG. 1 according to the embodiment of the invention.

FIG. 3 is a schematic diagram of an electronic device capable of safely storing and loading firmware according to another embodiment of the invention.

### DETAILED DESCRIPTION

The invention aims at providing a method and practical mechanism for safely/securely storing and loading firmware(s) wherein the provided method and mechanism are capable of reading an encrypted firmware from an external memory, rapidly and securely decrypting the encrypted firmware in a trusted execution environment (TEE), and loading the decrypted firmware into the trusted execution environment in which the decrypted firmware operates, so as to prevent the decrypted firmware from being invalidly/illegally accessed or modified by the other device(s), hacker(s), or other program(s) in a rich execution environment (REE). This method and mechanism can protect and ensure the confidentiality and integrity of firmware's storage and loading. Specifically, the provided method and mechanism in the invention is arranged to encrypt a firmware which is to be executed on an electronic device such as a circuit chip and then to store the encrypted firmware into a non-volatile memory (e.g. a flash memory, but not limited) outside the electronic device. Then, when the system of the electronic device is powered up, the electronic device's hardware decryption engine, software decryption engine/program, or a software and hardware combined decryption engine in the trusted execution environment can be employed to decrypt and check the integrity and authenticity of the firmware, and then data content of the decrypted firmware is transmitted through a secure direct memory access channel and/or by using a memory copy operation and then stored into a secure storage region in the trusted execution environment.

In addition, the key involved with the decryption operation in the invention is stored in a one-time programmable circuit of the trusted execution environment and within the electronic device. The key can be seen by only the trusted program(s) running in the trusted execution environment, and any program or malware running in the open execution environment cannot steal or tamper the key. In addition, the complete firmware loading procedure described in the invention, comprising key reading, decryption operations, and data transmission of the decrypted firmware, are performed and completed in the trusted execution environment, to avoid information leakage.

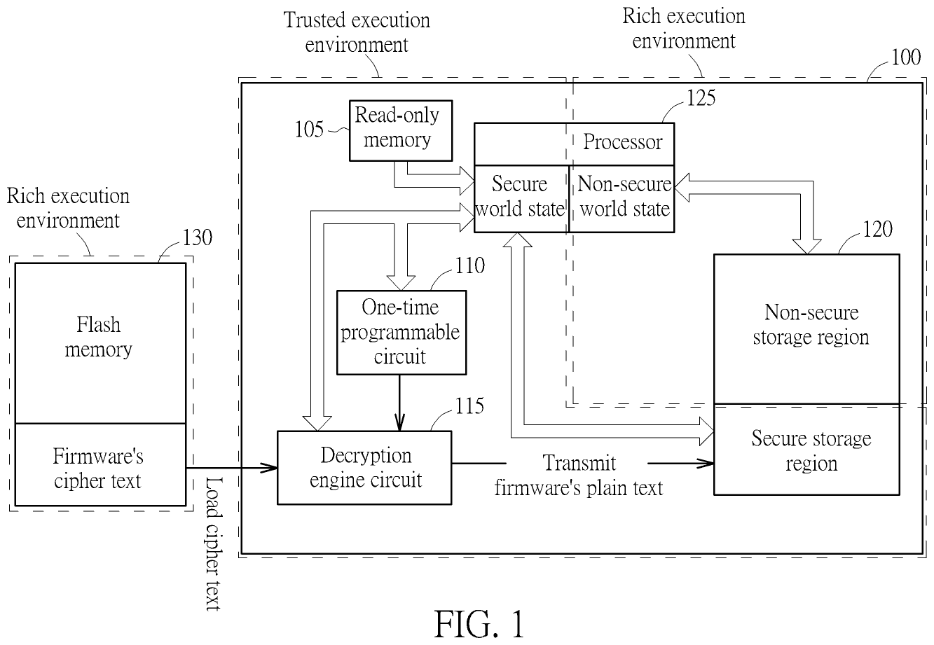

In practice, please refer to FIG. 1. FIG. 1 is a schematic diagram of an electronic device 100 capable of safely/securely storing and loading a firmware according to an embodiment of the invention. The electronic device 100 for example is a circuit chip and its operating system environment (i.e. resources) can be isolated and divided/classified into a secure world and a non-secure world respectively. The secure world in the invention is the trusted execution environment such as a trust zone specified by TrustZone solution proposed by ARM Holdings (but not limited), and the non-secure world in the invention is the open execution environment such as a normal or common zone defined in the TrustZone solution proposed by ARM Holdings (but not limited). The electronic device 100 comprises a read-only memory (ROM) 105, a one-time programmable circuit 110, a decryption engine circuit 115, a random access memory (RAM) 120, and a processor 125. The software and hardware resources of the electronic device 100 are correspondingly divided/classified and respectively allocated into the secure world and the non-secure world. As shown by the dotted areas in FIG. 1, the resources allocated into the secure world can be accessed by only the program(s) in secure world. When a program classified into the secure world runs on the processor 125, the processor 125 becomes at a secure world state. Instead, the resources allocated into the non-secure world can be accessed by all the programs in the secure world or non-secure world. When a program classified into the non-secure world runs on the processor 125, the processor 125 becomes at a non-secure world state.

In addition, the electronic device 100 is externally coupled to a non-volatile memory such as a flash memory 130. All the read-only memory 105, one-time programmable circuit 110, and decryption engine circuit 115 are classified into (or belong to) or within the secure world of the operating system environment of the electronic device 100. That is, the read-only memory 105, one-time programmable circuit 110, and decryption engine circuit 115 are equivalent to resources of the secure world and cannot be maliciously stolen or tampered with by hackers. The flash memory 130 is classified into (or belongs to) or within the non-secure world of the operating system environment of the electronic device 100, i.e. the resources of the non-secure world, and may be maliciously stolen or tampered with by hackers. In addition, the random access memory 120 of the electronic device 100 can be divided and allocated into two regions wherein a region (for example referred to as the secure storage region) is classified into the resources of the secure world and the other region (for example referred to as the normal storage region) is classified into the resources of the non-secure world. The secure storage region (i.e. secure area) and normal storage region (i.e. non-secure area) of the random access memory 120 can be seen on FIG. 1.

The flash memory 130 is used to store data of an encrypted firmware, that is, a cipher text of the firmware data. A user or an operator may start and execute a firmware encryption operation physically to generate the encrypted firmware data without Internet connections, and the firmware encryption operation for example may be used to calculate a hash value of the firmware data before encrypted (i.e. the plain text of the firmware) and then to use an encryption algorithm to encrypt the plain text of the firmware to generate the cipher text of the firmware; the encryption algorithm may be a symmetric encryption algorithm or an asymmetric encryption algorithm, and this is not intended to be a limitation of the invention.

The one-time programmable circuit 110 is used to store the key that is used by the user or operator to perform the firmware encryption operation upon the plain text of the firmware. The key cannot be modified or tampered with after being written into the one-time programmable circuit 110. The one-time programmable circuit 110 is classified into the resources of the secure world, and only program(s) belonging to or classified into the secure world can access or read the key. Program(s) classified into the non-secure world has/have no permissions to read the key and also cannot modify the key, and thus the use of one-time programmable circuit 110 can ensure that the storage of the key is safe and secure.

The read-only memory 105 is used to store a specific initialization program code such as a boot loader. The decryption engine circuit 115 is used to decrypt the firmware. The processor 125 is coupled to the read-only memory 105, one-time programmable circuit 110, and the decryption engine circuit 115. In this embodiment, for example, when/after the system of the electronic device 100 is powered up, the processor 125 according to a default/preset setting is used to start and execute a reset handler of the read-only memory 105 e.g. from a firmware module, to perform boot up and start up. The reset handler, from the read-only memory 105, loads and executes the initialization program code and uses the initialization program code to initialize the decryption engine circuit 115. The decryption engine circuit 115 after being initialized is arranged to obtain or retrieve the key from the one-time programmable circuit 110, load and set/configure the key into the initialized decryption engine circuit 115, read the cipher text of the firmware from the flash memory 130, use the key to decrypt the cipher text of the firmware to generate the plain text of the firmware, and to determine whether the secure boot procedure is successful (successfully completes) according to the cipher text of the firmware and the plain text of the firmware.

In addition, the decrypted plain text of the firmware can be moved to and stored in the secure storage region of the random access memory 120 through a secure direct memory access channel and/or by using a memory copy operation. The secure direct memory access channel is located within a hardware-implemented decryption engine circuit 115 or within a direct memory peripheral device, and the channel can be only accessed and controlled by the trusted program(s) in the secure world, and cannot be controlled by untrusted program(s) in the non-secure world. Thus, the data movement and storage of the decrypted plain text of the firmware can be also protected.

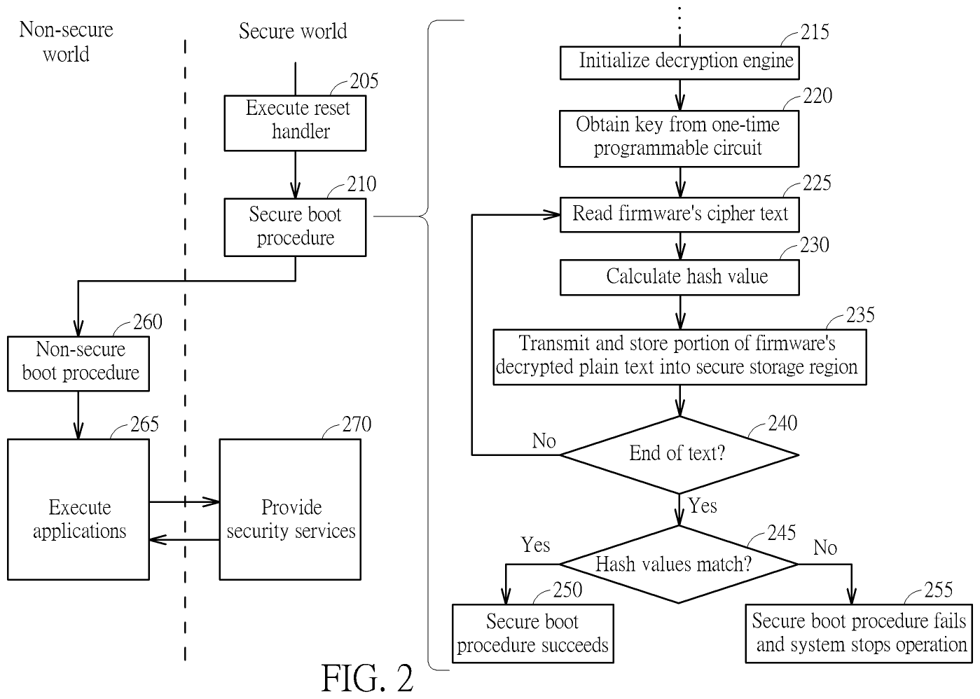

Please refer to FIG. 2. FIG. 2 is a schematic diagram of an example flow of the startup program of the electronic device 100 shown in FIG. 1 according to the embodiment of the invention. As shown in FIG. 2, when the electronic device 100 is powered up, electronic device 100 according to a reset setting starts and executes the reset handler of the read-only memory 105 (Step 205), and the reset handler loads the startup program from the read-only memory 105 to sequentially load and verify each portion of the startup program code(s) to be executed. For example, the reset handler can verify the authenticity of the startup program. When it is determined or confirmed that the startup program has not been tampered with, the reset handler can load the startup program into the secure storage region of the random access memory 120. Then, the electronic device 100 jumps to execute the startup program. The Step of this process is referred to as a secure boot procedure, i.e. Step 210.

In practice, Step 210 includes multiple sub-steps (that is, Step 215 to Step 255). In Step 215, the processor 125 executes the specific initialization program code to initialize the decryption engine circuit 115 to select and set/configure a specified decryption algorithm which is consistent with the algorithm used in the aforementioned encryption operation, and the decryption algorithm for example may be a decryption algorithm employed by a Cipher Block Chaining (CBC) of an Advanced Encryption Standard (AES) in a block encryption working mode or may be a decryption algorithm used by Galois/Counter Mode (GCM) of the Advanced Encryption Standard; this is not intended to be a limitation of the invention. Alternatively, in the invention an asymmetric encryption standard may be used to implement encryption and decryption operations. In Step 220, the decryption engine circuit 115 obtains or retrieves the key from the one-time programmable circuit 110 and loads the key. In Step 225, the decryption engine circuit 115 reads a part/portion of the cipher text of firmware from the flash memory 130, e.g. the first part/portion of the cipher text of firmware. In Step 230, the decryption engine circuit 115 uses the key to decrypt the read part/portion of the cipher text of firmware (that is, the first part/portion) to generate a part/portion of the plain text of firmware (for example, the first part/portion of the plain text of firmware), and then calculates a hash value according to one or more decrypted portions of the plain text of firmware. In Step 235, the decryption engine circuit 115 transmits and stores the decrypted part/portion of the plain text of firmware (that is, the first part/portion of the plain text of firmware) into the secure storage region of the random access memory 120.

In Step 240, the decryption engine circuit 115 determines whether the end of the cipher text of firmware has been read (that is, determining whether the last part/portion has been read). If the last part/portion has been read, then the flow proceeds to Step 245. Otherwise, if the last part/portion is not yet read, then the flow proceeds to Step 225, and the decryption engine circuit 115 then is arranged for reading the next part/portion of the cipher text of firmware from the flash memory 130, e.g. the second part/portion of the cipher text of firmware, using the key to decrypt the second read part/portion of the cipher text of firmware to generate the second part/portion of the plain text of firmware, calculating or updating the hash value according to one or more parts/portions of the plain text of firmware which have been decrypted, and transmitting and storing the second part/portion of the plain text of firmware, which is decrypted, into the secure storage region of the random access memory 120.

When the decryption engine circuit 115 has read out and decrypted the full cipher text of firmware file, the decryption engine circuit 115 in Step 245 is arranged to determine whether the hash value, calculated or updated based on the decrypted full plain text of firmware, matches the hash value appended and recorded in the original file content of the cipher text of firmware before being decrypted. If the two hash values exactly match with each other, then it means the cipher text of firmware stored in the flash memory 130 is not tempered with, and the flow proceeds to Step 250 in which it indicates that the secure boot procedure successfully completes (i.e. successful). If the two hash values are not matched, then it means that the original file content of the cipher text of firmware stored in the flash memory 130 has been tampered with by hackers, and the flow proceeds to Step 255 in which it indicates that the secure boot procedure fails; in this situation, the system of the electronic device 100 will be stopped. In this case, the data of the plain text of firmware stored in the secure storage region of the random access memory 120, which has been tampered with, will be cleared.

After the secure boot procedure successfully completes, the electronic device 100 enters Step 260 to activate and execute a non-secure boot loader to perform a non-secure boot procedure, and then in Step 265 one or more applications can be executed by the electronic device 100. In addition, the operations of Step 265 and Step 270 may be jumped and switched limitedly. In Step 270, the system of the electronic device 100 can execute the firmware to provide security services.

It should be noted that, as shown in FIG. 2, the operations of Step 260 and Step 265 belong to the resources of the non-secure world resources of the system, and the operations of other Steps (including Step 205 to Step 255 and Step 270) belong to the resources of the secure world of the system.

Further, in other embodiments, the decryption operation being performed upon the cipher text of firmware may be implemented by using the hardware-implemented decryption engine circuit 115 with software program(s). For example, the processor 125 can use a program code of the secure world to read the key stored in the one-time programmable circuit 110 to load the read key into the decryption engine circuit 115. Since the hardware-implemented decryption engine circuit 115 and the one-time programmable circuit 110 are classified into the resources of the secure world and can be accessed by only one or more programs of the secure world, the entire or whole procedure of key reading, loading and hardware decryption is safe.

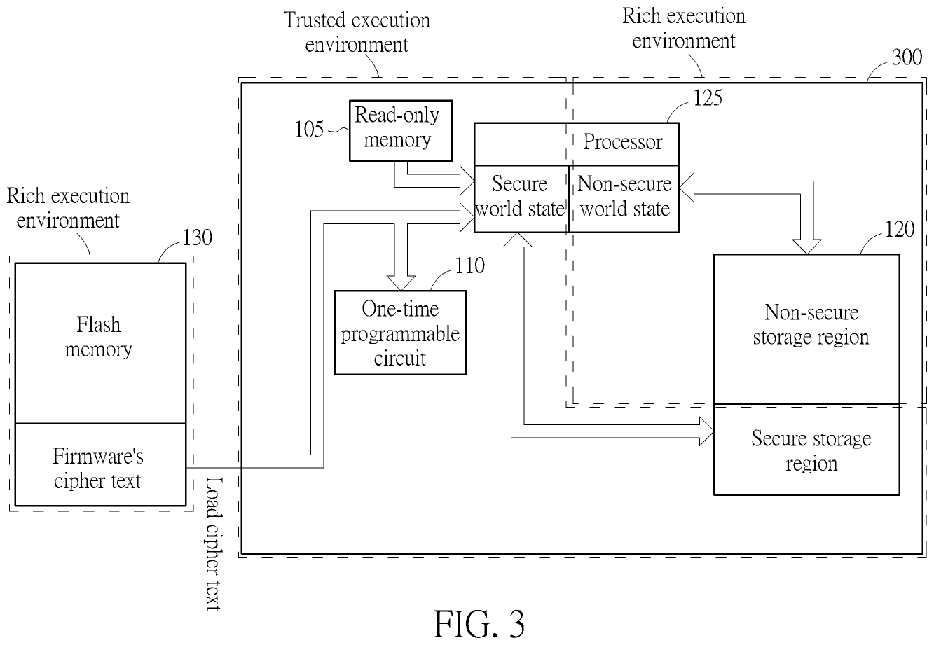

Further, in other embodiments, the decryption operation of the cipher text of firmware may also be implemented by using a pure software decryption engine program without hardware decryption. Please refer to FIG. 3. FIG. 3 is a schematic diagram of an electronic device 300 capable of safely storing and loading firmware according to another embodiment of the invention. As shown in FIG. 3, the electronic device 300 does not include the hardware decryption engine 115 shown in FIG. 1. The pure software decryption engine program is stored in a non-volatile memory in the secure world, and the processor 125 is arranged for using the program of the secure world to load the cipher text of firmware stored in flash memory 130, reading the key stored in the one-time programmable circuit 110, and loading and configuring the read key into the pure software decryption engine program, performing the decryption operation upon the read cipher text of firmware to generate the plain text of firmware, and transmitting and writing the generated plain text of firmware into the secure storage region of random access memory 120. It should be noted that, when the pure software decryption engine program is employed to perform the decryption operation, all the sub-steps of Step 210 in the secure boot procedure shown in FIG. 2 are implemented by the processor 125 to execute the pure software decryption engine program to perform the decryption operation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for securely storing and loading a firmware, comprising:
dividing an operating system environment of an electronic device into a secure world and a non-secure world wherein the secure world comprises a read-only memory and a one-time programmable circuit which are configured within the electronic device while the non-secure world comprises a flash memory externally coupled to the electronic device;
starting and executing a reset handler of the read-only memory to load a specific initialization program code when a system of the electronic device is powered up;
using the specific initialization program code to initialize a decryption engine;
obtaining a key from the one-time programmable circuit and loading the key into the decryption engine;
reading a cipher text of the firmware from the flash memory;
decrypting the cipher text of the firmware to generate a plain text of the firmware by using the decryption engine and the key; and
determining whether a secure boot procedure successfully completes according to the cipher text of the firmware and the plain text of the firmware.

2. The method of claim 1, wherein the determining step comprises:
calculating a specific hash value according to the plain text of the firmware;
transmitting and storing information content of the plain text of the firmware into a secure storage region of the secure world; and
determining whether the secure boot procedure successfully completes by determining whether the specific hash value matches a hash value recorded in the cipher text of the firmware.

3. The method of claim 2, wherein when the specific hash value matches the hash value recorded in the cipher text of the firmware, it is determined that the secure boot procedure successfully completes; and, when the specific hash value does not match the hash value recorded in the cipher text of the firmware, it is determined that the secure boot procedure fails.

4. The method of claim 2, further comprising:
reading a portion of the cipher text of the firmware from the flash memory;
decrypting the portion of the cipher text of the firmware to generate a portion of the plain text of the firmware by using the decryption engine and the key;
calculating the specific hash value according to content of the plain text of the firmware which has been read; and
transmitting and storing information content of the portion of the plain text of the firmware into the secure storage region located within the secure world.

5. The method of claim 4, further comprising:
after transmitting and storing the information content of the portion of the plain text of the firmware into the secure storage region located within the secure world, determining whether the portion of the cipher text of the firmware is a last portion of the cipher text of the firmware;
when the portion of the cipher text of the firmware is the last portion of the cipher text of the firmware, determining whether the specific hash value matches the hash value recorded in the cipher text of the firmware to determine whether the secure boot procedure successfully completes; and
when the portion of the cipher text of the firmware is not the last portion of the cipher text of the firmware, continuing to read a next portion of the cipher text of the firmware and using the decryption engine and the key to decrypt the next portion of the cipher text of the firmware so as to calculate the specific hash value according to the content of the plain text of the firmware which has been read.

6. The method of claim 2, wherein the information content of the plain text of the firmware is transmitted and stored into the secure storage region located within the secure world through a secure direct memory access channel or by using a memory copy operation.

7. The method of claim 1, wherein the decryption engine is one of a decryption engine hardware circuit, a decryption engine software program, and a hardware and software combined decryption engine.

8. An electronic device capable of securely storing and loading a firmware, the electronic device being externally coupled to a flash memory which belongs to a non-secure world of an operating system environment of the electronic device, and the electronic device comprises:
a read-only memory, for storing a specific initialization program code, the read-only memory belongs to a secure world of the operating system environment of the electronic device;
a one-time programmable circuit, for storing a key, the one-time programmable circuit belongs to the secure world of the operating system environment of the electronic device;
a decryption engine circuit, for decrypting the firmware, the decryption engine circuit belongs to the secure world of the operating system environment of the electronic device; and
a processor, coupled to the read-only memory, the one-time programmable circuit, and the decryption engine circuit, the processor based on a default/preset setting is arranged for starting and executing a reset handler of the read-only memory to perform boot up and start up and for loading an initialization program code when a system of the electronic device is powered up, and using the initialization program code to initiate the decryption engine circuit;
wherein the decryption engine circuit after being initialized is arranged for obtaining the key from the one-time programmable circuit and loading and configuring the key into the initialized decryption engine circuit, reading a cipher text of the firmware from the flash memory, decrypting the cipher text of the firmware to generate a plain text of the firmware by using the key, and determining whether a secure boot procedure successfully completes according to the cipher text of the firmware and the plain text of the firmware.

9. The electronic device of claim 8, wherein the decryption engine circuit is arranged for calculating a specific hash value according to the plain text of the firmware, transmitting and storing information content of the plain text of the firmware into a secure storage region located within the secure world, and determining whether the specific hash value matches a hash value recorded in the cipher text of the firmware so as to determine whether the secure boot procedure successfully completes.

10. The electronic device of claim 9, wherein when the specific hash value matches the hash value recorded in the cipher text of the firmware, the decryption engine circuit is arranged for determining whether the secure boot procedure successfully completes; and, when the specific hash value does not match the hash value recorded in the cipher text of the firmware, the decryption engine circuit determines that the secure boot procedure fails.

11. The electronic device of claim 9, wherein the decryption engine circuit is used for:
reading a portion of the cipher text of the firmware from the flash memory;
using the key to decrypt the portion of the cipher text of the firmware to generate a portion of the plain text of the firmware;
calculating the specific hash value according to a content of the plain text of the firmware which has been read; and
transmitting and storing information content of the portion of the plain text of the firmware into the secure storage region located within the secure world.

12. The electronic device of claim 11, wherein the decryption engine circuit is used for:
determining whether the portion of the cipher text of the firmware is a last portion of the cipher text of the firmware after transmitting and storing the information content of the portion of the plain text of the firmware into the secure storage region located within the secure world;
when the portion of the cipher text of the firmware is the last portion of the cipher text of the firmware, determining whether the specific hash value matches the hash value recorded in the cipher text of the firmware so as to determine whether the secure boot procedure successfully completes; and
when the portion of the cipher text of the firmware is not the last portion of the cipher text of the firmware, continuing to read a next portion of the cipher text of the firmware, and using the decryption engine and the key to decrypt the next portion of the cipher text of the firmware so as to calculate the specific hash value according to the content of the plain text of the firmware which has been read.

13. The electronic device of claim 9, wherein the information content of the plain text of the firmware is transmitted and stored into the secure storage region of the secure world through a secure direct memory access channel or by using a memory copy operation.

14. The electronic device of claim 8, wherein the decryption engine circuit is one of a decryption engine hardware circuit and a software and hardware combined decryption engine.

15. An electronic device capable of securely storing and loading a firmware, the electronic device being externally coupled to a flash memory which belongs to a non-secure world of an operating system environment of the electronic device, and the electronic device comprises:
a read-only memory, for storing a specific initialization program code, the read-only memory belongs to a secure world of the operating system environment of the electronic device;
a one-time programmable circuit, for storing a key, the one-time programmable circuit belongs to the secure world of the operating system environment of the electronic device; and
a processor, coupled to the read-only memory and the one-time programmable circuit, the processor based on a default/preset setting is arranged for starting and executing a reset handler of the read-only memory to perform boot up and start up and for loading an initialization program code and using the initialization program code to initiate the decryption engine circuit when a system of the electronic device is powered up;
wherein the processor is arranged for obtaining the key from the one-time programmable circuit, loading and configuring the key into a decryption engine software program, reading a cipher text of the firmware from the flash memory, using the key and the decryption engine software program to decrypt the cipher text of the firmware to generate a plain text of the firmware, and determining whether a secure boot procedure successfully completes according to the cipher text of the firmware and the plain text of the firmware.
